(19) United States
(12) Patent Application Publication
(10) Pub. No.: US 2019/0388735 A1
(43) Pub. Date: Dec. 26, 2019

(54) RESIN COMPOSITION FOR GOLF BALL, AND GOLF BALL

(71) Applicant: Bridgestone Sports Co., Ltd., Tokyo (JP)

(72) Inventors: Katsunobu MOCHIZUKI, Chichibushi (JP); Masahiro YAMABE, Chichibushi (JP)

(73) Assignee: Bridgestone Sports Co., Ltd., Tokyo (JP)

(21) Appl. No.: 16/395,716

(22) Filed: Apr. 26, 2019

(30) Foreign Application Priority Data
Jun. 20, 2018 (JP) 2018-117140

(51) Int. Cl. A63B 37/00; C08L 75/08; C08G 18/76; C08G 18/48

(52) U.S. Cl. CPC A63B 37/0024; C08L 75/08; C08G 18/7671; C08G 18/4825; A63B 37/0076; A63B 37/0095; A63B 37/0073; A63B 37/0074; A63B 37/0027

(57) ABSTRACT

In a resin composition for golf balls that includes, as a primary ingredient, a polyurethane or polyurea, letting P1 be the absorbance peak height near a wave number of 697 cm⁻¹ and P2 be the absorbance peak height near a wave number of 1512 cm⁻¹ in the infrared absorption spectrum of the composition measured by ATR/FT-IR spectroscopy, the ratio P1/P2 is from 0.03 to 2.10. When used as a cover material in golf balls having a core and a cover of one or more layer, the resin composition keeps the ball from flying too far on approach shots and also gives the ball a good controllability without sacrificing distance on shots with a driver.

### CROSS-REFERENCE TO RELATED APPLICATION

This non-provisional application claims priority under 35 U.S.C. § 119(a) on Patent Application No. 2018-117140 filed in Japan on Jun. 20, 2018, the entire contents of which are hereby incorporated by reference.

### TECHNICAL FIELD

The present invention relates to a resin composition for golf balls and to a golf ball in which the composition is used. More particularly, the invention relates to a resin composition which can be suitably used as the cover material in golf balls having a core encased by a cover of one or more layers, and to a golf ball in which such a composition is used.

### BACKGROUND ART

The chief characteristic demanded of golf balls is an increased distance, although other desired properties include the ability of the ball to stop well on approach shots, and scuff resistance. Many golf balls endowed with a good flight on shots with a driver and a good receptivity to backspin on approach shots have hitherto been developed. In addition, golf ball cover materials possessing a high resilience and a good scuff resistance have been developed.

Today, urethane resin materials are often used in place of ionomer resin materials as the cover material, especially in golf balls for professional golfers and skilled amateur golfers. However, professional golfers and skilled amateur golfers desire golf balls having even better controllability on approach shots, and so further improvement is sought even among cover materials in which a urethane resin material serves as the base resin. JP-A 2017-113220 discloses a golf ball resin material which includes, as a cover material that endows the ball with excellent controllability around the green when played with a short iron such as a sand wedge and that can also extend the distance traveled by the ball on shots with a driver, a specific styrene-based thermoplastic elastomer and a thermoplastic resin having on the molecule either styrene monomer units or diene monomer units. Also, JP-A 2016-119946 discloses a resin material for golf balls that is composed primarily of a styrene-butadiene-styrene block copolymer and provides the ball with excellent controllability when hit around the green with a short iron such as a sand wedge.

However, these golf ball resin materials are completely different resin materials that are intended for use in place of ionomer resins and urethane resins, and are sometimes unable to fully achieve the scuff resistance of urethane resins.

### SUMMARY OF THE INVENTION

It is therefore an object of the present invention to provide a resin material for golf balls which keeps the ball from flying too far on approach shots and has a more delicate controllability around the green, and which moreover can maintain a good scuff resistance without a loss of distance on driver shots.

As a result of extensive investigations, we have discovered that, in order to further improve the properties of golf ball resin compositions containing polyurethane or polyurea as a primary ingredient that have hitherto been used in the structural elements of golf balls, especially the cover layer, by preparing a resin composition such that, letting P1 be the absorbance peak height near a wave number of 697 cm⁻¹ and P2 be the absorbance peak height near a wave number of 1512 cm⁻¹ in the infrared absorption spectrum of the composition as measured by the attenuated total reflectance (ATR) method using a Fourier transform infrared (FT-IR) spectrophotometer, the ratio P1/P2 is from 0.03 to 2.10, a golf ball having a structural element formed of this resin composition provides a competitive advantage because, particularly when used by professional golfers and skilled amateurs, it is easier to control on approach shots and yet does not sacrifice distance on shots with a driver.

The absorbance peak height P1 near a wave number of 697 cm⁻¹ as measured by ATR/FT-IR spectroscopy represents monosubstituted benzene C—H out-of-plane bending vibrations attributable to styrene constituents, and the absorbance peak height P2 near a wave number of 1512 cm⁻¹ represents amide groups (NHCO groups) in urethane linkages or urea linkages. The P1/P2 value therebetween provides a quantitative balance between the polyurethane or polyurea serving as the primary ingredient of the resin and the styrene constituents, thereby achieving the desired golf ball properties.

Accordingly, in a first aspect, the invention provides a resin composition for golf balls that includes polyurethane or polyurea as a primary ingredient, wherein, letting P1 be the absorbance peak height near a wave number of 697 cm⁻¹ and P2 be the absorbance peak height near a wave number of 1512 cm⁻¹ when the infrared absorption spectrum measured by the attenuated total reflectance method in Fourier transform infrared absorption spectroscopy (ATR/FT-IR spectroscopy) is plotted as absorbance versus wave number, the ratio P1/P2 is from 0.03 to 2.10.

In a preferred embodiment, the resin composition of the invention further includes one or more resin selected from the group consisting of polystyrene (PS), general-purpose polystyrene resins (GPPS), high-impact polystyrene resins (HIPS), styrene-isoprene-styrene block copolymers (SIS), styrene-butadiene-styrene block copolymers (SBS), styrene-ethylene/butadiene-styrene block copolymers (SEBS), styrene-ethylene/isoprene-styrene block copolymers (SEPS), acrylonitrile/styrene copolymers (AS), acrylonitrile/ethylene-propylene-nonconjugated diene rubber/styrene copolymers (AES), acrylonitrile-butadiene/styrene copolymers (ABS), methyl methacrylate/butadiene/styrene copolymers (MBS) and acrylonitrile/styrene/acrylic rubber copolymers (ASA).

In another preferred embodiment of the resin composition of the invention, letting P3 be the absorbance peak height near a wave number of 2853 cm⁻¹ as measured by ATR/FT-IR spectroscopy, the value P2/P3 is 2.0 or less.

In yet another preferred embodiment, letting P4 be the absorbance peak height near a wave number of 1180 cm⁻¹ as measured by ATR/FT-IR spectroscopy, the value P4/P2 is 0.53 or less.

In still another preferred embodiment, the polyurethane serving as the primary ingredient of the resin composition is an ether-based thermoplastic polyurethane.

In a further preferred embodiment, the polyol component of the polyurethane serving as the primary component of the resin composition has a polyol component that includes polytetramethylene ether glycol (PTMG).

In a yet further preferred embodiment, the isocyanate component of the polyurethane or polyurea serving as the primary ingredient of the resin composition has an isocyanate component that is one or more selected from the group consisting of tolylene-2,6-diisocyanate, tolyene-2,4-diisocyanate, 4,4′-diphenylmethanediisocyanate, polymethylene polyphenyl polyisocyanate, 1,5-diisocyanatonaphthalene, isophorone diisocyanate (including isomer mixtures), dicyclohexylmethane-4,4′-diisocyanate, hexamethylene-1,6-diisocyanate, m-xylylene diisocyanate, hydrogenated xylylene diisocyanate, tolidine diisocyanate and norbornene diisocyanate, derivatives thereof, and prepolymers formed of these isocyanate compounds.

In a second aspect, the invention provides a golf ball having a core and a cover of one or more layer encasing the core, wherein at least one layer of the cover is formed of the resin composition according to the first aspect of the invention.

### Advantageous Effects of the Invention

The resin composition for golf balls of the invention is a resin composition which, given that the ball initial velocity on approach shots falls, as a result of which the contact time between the ball and the clubface at the time of impact increases and the ball does not fly excessively on approach shots, provides the golf ball with a delicate controllability around the green, and which moreover retains a good scuff resistance and durability without a loss of distance on shots with a driver. The inventive composition is particularly useful as a cover material for golf balls.

### BRIEF DESCRIPTION OF THE DIAGRAMS

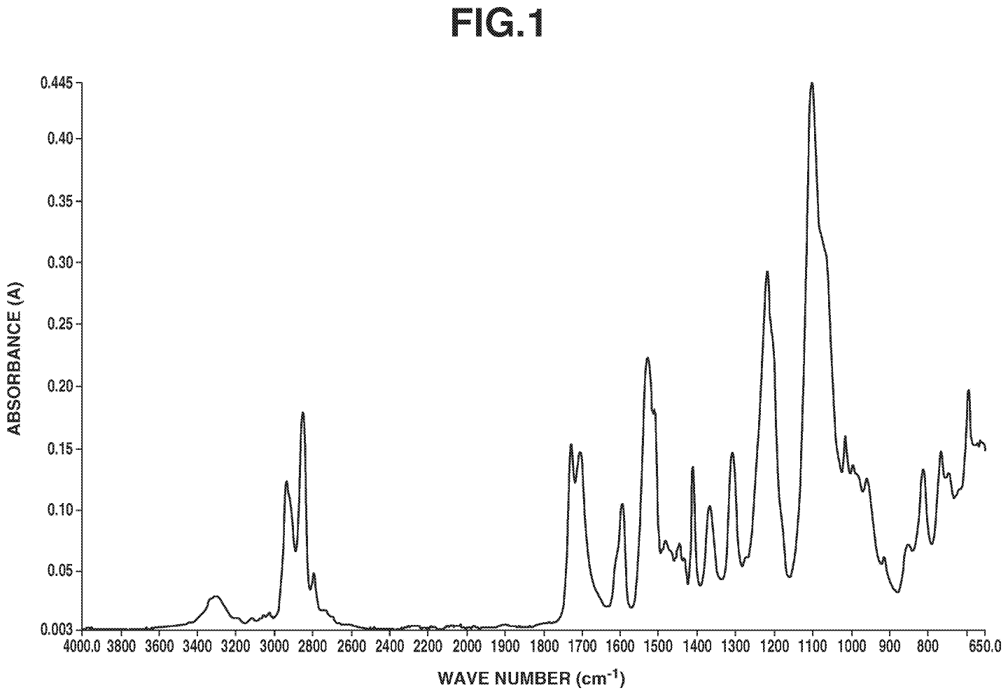

FIG. 1 shows an example of an infrared absorption spectrum (absorbance versus wave number) measured by ATR/FT-IR spectroscopy for a golf ball resin composition according to the invention.

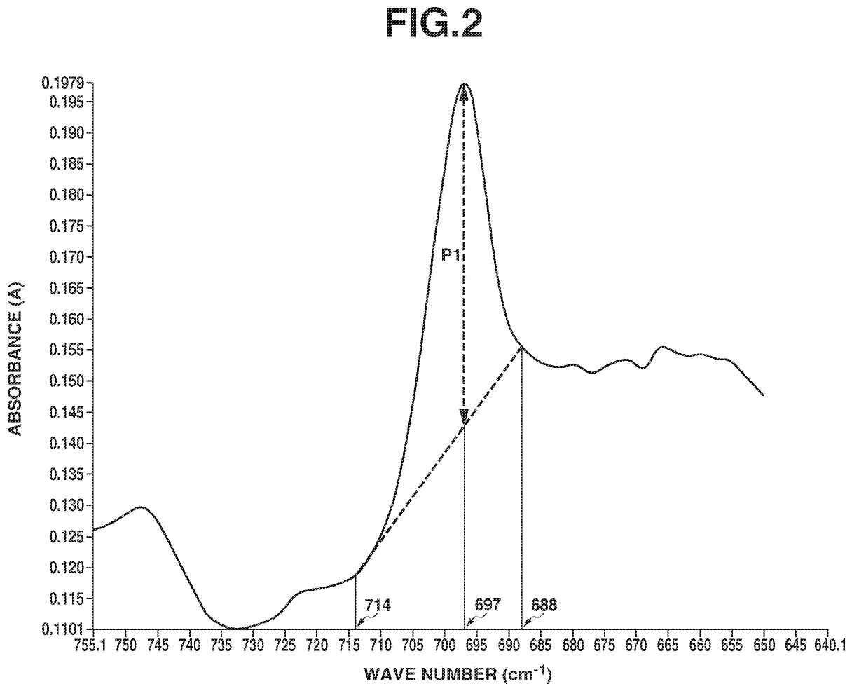

FIG. 2 is a partially enlarged view of the same infrared absorption spectrum for explaining the absorption peak height P1 near a wave number of 697 cm⁻¹.

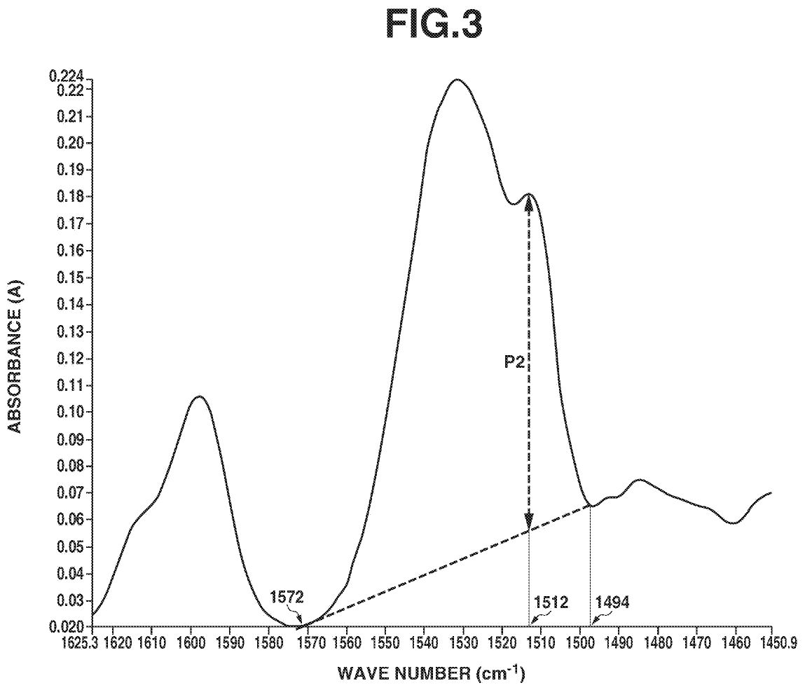

FIG. 3 is a partially enlarged view of the same infrared absorption spectrum for explaining the absorption peak height P2 near a wave number of 1512 cm⁻¹.

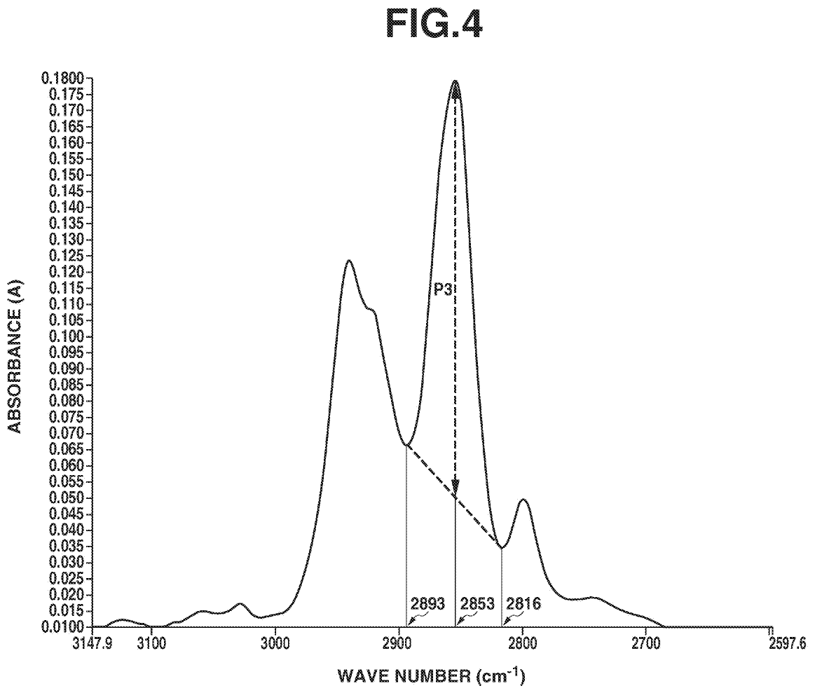

FIG. 4 is a partially enlarged view of the same infrared absorption spectrum for explaining the absorption peak height P3 near a wave number of 2853 cm⁻¹.

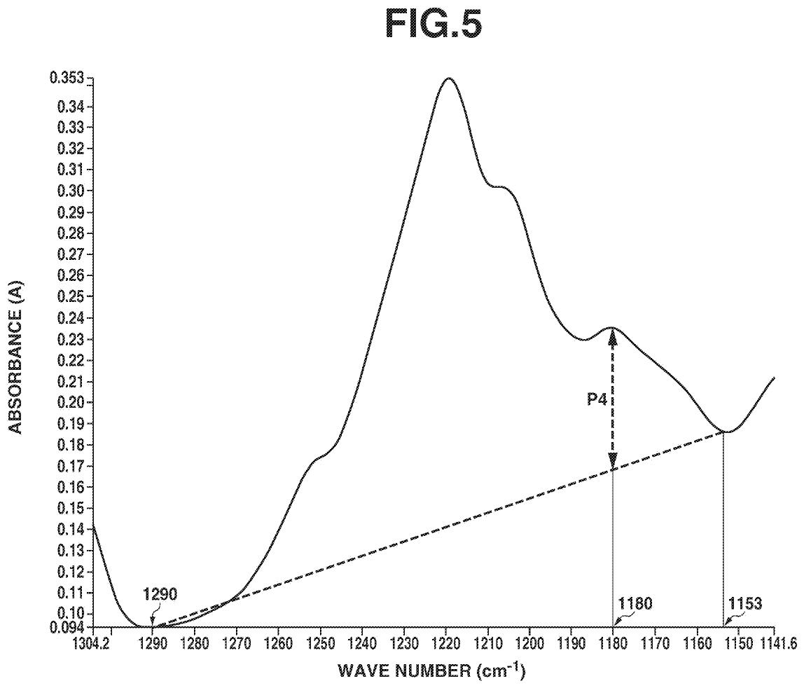

FIG. 5 is a partially enlarged view of the same infrared absorption spectrum for explaining the absorption peak height P4 near a wave number of 1180 cm⁻¹.

### DESCRIPTION OF THE PREFERRED EMBODIMENTS

The objects, features and advantages of the invention will become more apparent from the following detailed description taken in conjunction with the appended diagrams.

The golf ball resin composition of the invention includes polyurethane or polyurea as a primary ingredient. Details on the polyurethane or polyurea are given below.

### Polyurethane

The polyurethane has a structure which includes soft segments composed of a polymeric polyol (polymeric glycol) that is a long-chain polyol, and hard segments composed of a chain extender and a polyisocyanate. Here, the polymeric polyol serving as a starting material may be any that has hitherto been used in the art relating to polyurethane materials, and is not particularly limited. This is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include poly(ethylene glycol), poly(propylene glycol), poly(tetramethylene glycol) and poly(methyltetramethylene glycol). Such long-chain polyols may be used singly, or two or more may be used in combination.

It is particularly suitable to use a polyether-based polyol as the polyol component. The use of a polyol that includes polytetramethylene ether glycol (PTMG) is especially preferred.

The long-chain polyol preferably has a number-average molecular weight in the range of 1,000 to 5,000. By using a long-chain polyol having a number-average molecular weight in this range, golf balls made with a polyurethane composition that have excellent properties, including a good rebound and a good productivity, can be reliably obtained. The number-average molecular weight of the long-chain polyol is more preferably in the range of 1,500 to 4.000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used as the chain extender. In this invention, low-molecular-weight compounds with a molecular weight of less than 1,000 which have on the molecule two or more active hydrogen atoms capable of reacting with isocyanate groups may be used. Of these, preferred use can be made of aliphatic diols having from 2 to 12 carbon atoms. Specific examples include 1,4-butylene glycol, 1,2-ethylene glycol, 1,3-butanediol, 1,6-hexanediol and 2,2-dimethyl-1,3-propanediol. Of these, the use of 1,4-butylene glycol is especially preferred. The number-average molecular weight of the chain extender is preferably less than 800, and more preferably less than 600.

Any polyisocyanate hitherto employed in the art relating to polyurethanes may be suitably used without particular limitation as the polyisocyanate. For example, use may be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method of preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

The polyurethane is exemplified by thermoplastic polyurethane materials. In particular, from the standpoint of rebound and, assuming outdoor use, durability, the use of an ether-based thermoplastic polyurethane material is preferred. The thermoplastic polyurethane material may be a commercial product, examples of which include those available under the trade name Pandex from DIC Covestro Polymer, Ltd., and those available under the trade name Resamine from Dainichiseika Color & Chemicals Mfg. Co., Ltd.

### Polvurea

The polyurea is a resin composition composed primarily of urea linkages formed by reacting (i) an isocyanate with (ii) an amine-terminated compound. This resin composition is described in detail below.

### (i) Isocyanate

The isocyanate is preferably one that is used in the prior art relating to polyurethanes, but is not particularly limited. Use may be made of isocyanates similar to those mentioned above in connection with the polyurethane material.

### (ii) Amine-Terminated Compound

An amine-terminated compound is a compound having an amino group at the end of the molecular chain. In this invention, the long-chain polyamines and/or amine curing agents shown below may be used.

A long-chain polyamine is an amine compound which has on the molecule at least two amino groups capable of reacting with isocyanate groups, and which has a number-average molecular weight of from 1,000 to 5,000. In this invention, the number-average molecular weight is more preferably from 1,500 to 4,000, and even more preferably from 1,900 to 3,00). Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

An amine curing agent is an amine compound which has on the molecule at least two amino groups capable of reacting with isocyanate groups, and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine), 1,3-cyclohexane bis(methylamine), diethylene glycol di(aminopropyl) ether, 2-methylpentamethylenediamine, diaminocyclohexane, diethylenetriamine, triethylenetetramine, tetraethylenepentamine, propylenediamine, 1,3-diaminopropane, dimethylaminopropylamine, diethylaminopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroaniline), 3,5-dimethylthio-2,4-toluenediamine, 3,5-dimethylthio-2,6-toluenediamine, 3,5-diethylthio-2,4-toluenediamine, 3,5-diethylthio-2,6-toluenediamine, 4,4′-bis(sec-butylamino)diphenylmethane and derivatives thereof, 1,4-bis(sec-butylamino)benzene, 1,2-bis(sec-butylamino)benzene. N,N′-dialkylaminodiphenylmethane, N,N,N′,N′-tetrakis(2-hydroxypropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to the above-described components (i) and (ii), a polyol may also be included in the polyurea. The polyol is not particularly limited, but is preferably one that has hitherto been used in the art relating to polyurethanes. Specific examples include the long-chain polyols and/or polyol curing agents mentioned below.

The long-chain polyol may be any that has hitherto been used in the art relating to polyurethanes. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used singly or two or more may be used in combination.

The long-chain polyol has a number-average molecular weight of preferably from 1,000 to 5,000, and more preferably from 1.700 to 3,500. In this average molecular weight range, an even better resilience and productivity are obtained.

The polyol curing agent is preferably one that has hitherto been used in the art relating to polyurethanes, but is not subject to any particular limitation. In this invention, use may be made of a low-molecular-weight compound having on the molecule at least two active hydrogen atoms capable of reacting with isocyanate groups, and having a molecular weight of less than 1,000. Of these, the use of aliphatic diols having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight of preferably less than 800, and more preferably less than 600.

A known method may be used to produce the polyurea. A prepolymer process, a one-shot process or some other known method may be suitably selected for this purpose.

From the standpoint of the spin properties and scuff resistance obtained in the golf ball, the polyurethane or polyurea resin itself has a material hardness on the Shore D scale which is preferably 65 or less, more preferably 60 or less, and even more preferably 55 or less. From the standpoint of moldability, the lower limit on the Shore D hardness scale is preferably at least 25 or more, and more preferably 30 or more.

The above polyurethane or polyurea resin is the primary ingredient, i.e., the base resin, of the resin composition. To fully impart the scuff resistance of the polyurethane resin or polyurea resin, it accounts for at least 50 wt %, preferably at least 60 wt %, more preferably at least 70 wt %, even more preferably at least 80 wt %, and most preferably at least 90 wt %, of the resin composition.

The resin composition of the invention is characterized in that, letting P1 be the absorbance peak height near the wave number 697 cm⁻¹ and P2 be the absorbance peak height near the wave number 1512 cm⁻¹ when the infrared absorption spectrum measured by the attenuated total reflectance method in Fourier transform infrared absorption spectroscopy (ATR/FT-IR spectroscopy) is plotted as absorbance versus wave number, the ratio P1/P2 is from 0.03 to 2.10. The absorbance peak height P1 signifies the absorbance peak height when the infrared absorption spectrum from a wave number of 688 cm⁻¹ to 714 cm⁻¹ is used as the baseline reference, and absorbance peak height P2 signifies the absorbance peak height when the infrared absorption spectrum from a wave number of 1494 cm⁻¹ to 1572 cm⁻¹ is used as the baseline reference. The value P1/P2 is preferably from 0.08 to 2.00, and more preferably from 0.10 to 1.50.

Here, FIG. 1 shows the infrared absorption spectrum measured by ATR/FT-IR spectroscopy and plotted as absorbance versus wave number. FIG. 2, which is a partially enlarged view of the same spectrum, shows that the absorbance peak height P1 is the height when the spectrum from a wave number of 688 cm⁻¹ to 714 cm⁻¹ is used as the baseline reference. FIG. 3 similarly shows that the absorbance peak height P2 is the height when the spectrum from a wave number of 1494 cm⁻¹ to 1572 cm⁻¹ is used as the baseline reference. The absorbance peak height is computed relative to a baseline in order to correct for the variability in the measured values for absorbance that arises with each measurement. To increase the accuracy of the measured data, the absorbance peak height is determined by increasing the number of measurements (N) so that the percent relative standard deviation (also referred to below as “RSD”) becomes 3.0% or less. The percent relative standard deviation is expressed by the following formula.

Percent relative standard deviation=(standard deviation/average value)×100

ATR/FT-IR spectroscopy may be carried out in accordance with the method described in JIS K 0117 (2000).

The absorbance peak heights P1 and P2 signify peak intensities in the infrared absorption spectrum, with the absorbance peak height P1 near a wave number of 697 cm⁻¹ representing monosubstituted benzene C—H out-of-plane bending vibrations attributable to styrene constituents and the absorbance peak height P2 near a wave number of 1512 cm⁻¹ representing amide groups (NHCO groups) in urethane linkages. A larger numerical value for P1/P2 signifies a higher content of the styrene constituents included in the resin component. In terms of ball properties, this manifests as a larger decrease in the initial velocity of the ball on approach shots, the reason being that when the resin composition of the invention is used as a cover layer, the influence of the cover layer is larger under the low head speed striking conditions of an approach shot. Also, even when the P1/P2 value is to a certain extent large, there is substantially no decline in the initial velocity of the ball on driver shots. This is because, under the striking conditions of a driver shot, the overall ball construction has a larger influence and the initial velocity does not depend solely on the resin properties of the cover layer. However, when the P1/P2 value is too large, the initial velocity on shots with a driver may decrease.

In this invention, letting P3 be the absorbance peak height near a wave number of 2853 cm⁻¹ as measured by ATR/FT-IR spectroscopy, it is preferable for the value P2/P3 to be 2.0 or less. The absorbance peak height P3 near a wave number of 2853 cm⁻¹ represents C—H stretching vibrations. The value P2/P3 signifies the peak intensity ratio of amide bonds to C—H stretching. When this value is larger, there are more hard segments; that is, the resin tends to be harder or the molecular weight of the long-chain polyol tends to be lower. The P2/P3 value is more preferably 1.5 or less, and even more preferably 1.3 or less.

Also, letting P4 be the absorbance peak height near a wave number of 1180 cm⁻¹ as measured by ATR/FT-IR spectroscopy, it is preferable for the value P4/P2 to be 0.53 or less. The absorbance peak height P4 near a wave number of 1180 cm⁻¹ represents ester C—O stretching vibrations. The P4/P2 value signifies the peak intensity ratio of ester C—O stretching to amide groups. When this value is larger, the ester content tends to be higher. The P4/P2 value is more preferably 0.4 or less.

FIG. 4 shows that the absorbance peak height P3 near a wave number of 2853 cm⁻¹ is the height when the spectrum from a wave number of 2816 cm⁻¹ to 2893 cm⁻¹ is used as the baseline reference. Also, FIG. 5 shows that the absorbance peak height P4 near a wave number of 1180 cm⁻¹ is the height when the spectrum from a wave number of 1153 cm⁻¹ to 1290 cm⁻¹ is used as the baseline reference.

Hence, in this invention, by having polyurethane or polyurea serve as the base resin of the resin composition and by suitably including a styrene constituent-containing resin such that the ratio P1/P2 of the absorbance peak height P1 near a wave number of 697 cm⁻¹ to the absorbance peak height P2 near a wave number of 1512 cm⁻¹ when the infrared absorption spectrum measured by ATR/FT-IR spectroscopy is plotted as absorbance versus wave number is from 0.03 to 2.10, the ball initial velocity on approach shots falls. As a result, the contact time between the ball and the clubface at the time of impact increases and the ball does not fly excessively, allowing the ball to be hit hard and thus making it easier to control to the desired spin performance and enabling delicate controllability around the green. Moreover, the ball is able to retain a good scuff resistance and durability without a loss of distance on shots with a driver.

The styrene constituent-containing resin material (referred to below as the “styrenic resin material”) is exemplified by homopolymers of styrenic monomers such as styrene, α-methylstyrene, vinyltoluene, ethylstyrene, i-propylstyrene, t-butylstyrene, dimethylstyrene, bromostyrene and chlorostyrene; styrenic copolymers: and rubber-toughened styrene copolymers. Exemplary styrenic copolymers include polymers obtained by polymerizing one or more vinyl monomer, and copolymers obtained by copolymerizing one or more vinyl monomer with one or more monomer that is copolymerizable therewith. Exemplary rubber-toughened styrene copolymers include those having a structure in which a styrene monomer-containing copolymer is grafted onto a rubbery polymer, and those having a structure in which a styrene monomer-containing copolymer is not grafted onto a rubbery polymer. Examples of this rubbery polymer include conjugated diene rubber polymers such as polybutadiene, styrene-butadiene random or block copolymers, polyisoprene, polychloroprene, styrene-isoprene random, block or graft copolymers, ethylene-propylene rubber, and ethylene-propylene-diene rubber.

Examples of styrenic resin materials include styrenic polymers such as polystyrene (PS), rubber-toughened styrenic polymers such as general-purpose polystyrene resin (GPPS) and high-impact polystyrene resin (HIPS), styrenic copolymers such as acrylonitrile/styrene copolymer (AS), and rubber-toughened (co)polymers such as acrylonitrile/ethylene-propylene-nonconjugated diene rubber/styrene copolymer (AES), acrylonitrile/butadienestyrene copolymer (ABS), methyl methacrylate/butadiene-styrene copolymer (MBS) and acrylonitrile/styrene/acrylic rubber copolymer (ASA). Of these, the use of HIPS or GPPS is preferred. In particular, from the standpoint of increasing flowability during molding and yet being able to exhibit a rebound-lowering effect on approach shots, the use of HIPS is most preferred. In addition to a styrenic monomer, HIPS contains rubber ingredients such as butadiene. Examples include copolymers in which the rubber ingredient is copolymerized with a styrenic monomer, and resin blends of such a copolymer with another homopolymer or copolymer. In general-purpose polystyrene resins (GPPS), the resin ingredients aside from additives and the like consist substantially of styrene monomer.

“Styrenic resin material” also encompasses styrenic thermoplastic elastomers. Styrenic thermoplastic elastomers are block polymers which use polystyrene as the hard segments in the molecule, and use a polydiene such as polybutadiene or polyisoprene as the soft segments. Examples of styrenic thermoplastic elastomers include styrene-butadiene-styrene block copolymers (SBS) and styrene-isoprene-styrene block copolymers (SIS), styrene-ethylene/butadiene-styrene block copolymers (SEBS), styrene-ethylene/propylene-styrene block copolymers and styrene-ethylene/isoprene-styrene block copolymers (SEPS) obtained by the hydrogenation of these, and also hydrogenated polymers of random styrene-butadiene rubbers (HSBR), and mixtures of these with polypropylene.

Commercial products may be used as the styrenic resin material. Examples include DIC Styrene GPPS and DIC Styrene HIPS from DIC Corporation, RB 840 from JSR Corporation, Toyo Styrol GP and Toyo Styrol HI from Toyo Styrene Co., Ltd., PSJ Polystyrene GPPS and PSJ Polystyrene HIPS from PS Japan Corporation, EARNESTON from Kuraray Plastics Co., Ltd., and Tuftec and Tufprene from Asahi Kasei Corporation.

The styrenic resin material has a Shore D hardness of preferably 90 or less, more preferably 85 or less, and even more preferably 80 or less.

The styrenic resin material has a rebound resilience, as measured according to JIS-K 6255, of preferably 60% or less, more preferably 55% or less, even more preferably 50% or less, and most preferably 45% or less. By holding down the rebound resilience in this way, a reduction in the ball initial velocity on approach shots can be achieved at a small amount of addition without adversely affecting the golf ball properties. To minimize a decline in rebound and a reduction in distance on shots with a driver, the lower limit in the rebound resilience is preferably at least 20%.

The styrenic resin material has a flexural modulus, as measured according to JIS-K 7171, of preferably not more than 3,500 MPa, more preferably not more than 3,400 MPa, even more preferably not more than 3,000 MPa, and most preferably not more than 2,600 MPa. By thus holding down the flexural modulus, the initial velocity of the ball on approach shots can be reduced without adversely affecting the golf ball properties. The lower limit in the flexural modulus is preferably at least 1.800 MPa

The content of the styrenic resin material per 100 parts by weight of the polyurethane or polyurea serving as the primary ingredient is preferably from 0.5 to 60 parts by weight, more preferably from 1 to 25 parts by weight, and even more preferably from 2 to 15 parts by weight. When this content is low, the ball initial velocity-lowering effect on approach shots decreases as well. Also, this resin composition is fully responsible for the scuff resistance properties possessed by the urethane resin serving as the base resin and so an excessive content of the styrenic resin material may result in a loss of scuff resistance.

In addition to the above resin components, other resin materials may also be included in the golf ball resin composition of the invention. The purpose for doing so is, for example, to further improve the flowability of the golf ball resin composition and to increase various properties of the golf ball such as rebound and scuff resistance.

The other resin materials may be selected from among polyester elastomers, polyamide elastomers, ionomer resins, ethylene-ethylene/butylene-ethylene block copolymers and modified forms thereof, polyacetals, polyethylenes, nylon resins, methacrylic resins, polyvinyl chlorides, polycarbonates, polyphenylene ethers, polyarylates, polysulfones, polyethersulfones, polyetherimides and polyamideimides. These may be used singly or two or more may be used together.

In addition, an active isocyanate compound may be included in the resin composition of the invention. This active isocyanate compound, by reacting with the polyurethane or polyurea serving as the primary ingredient, can further increase the scuff resistance of the overall resin composition. Moreover, the plasticizing effect of the isocyanate can increase the flowability of the resin composition and improve the moldability.

Any isocyanate compound employed in conventional polyurethanes may be used without particular limitation as the above isocyanate compound. For example, aromatic isocyanate compounds that may be used include 2,4-toluene diisocyanate, 2,6-toluene diisocyanate and mixtures of both, 4,4-diphenylmethane diisocyanate, m-phenylene diisocyanate and 4,4′-biphenyl diisocyanate. Use can also be made of the hydrogenated forms of these aromatic isocyanate compounds, such as dicyclohexylmethane diisocyanate. Other isocyanate compounds that may be used include aliphatic diisocyanates such as tetramethylene diisocyanate, hexamethylene diisocyanate (HDI) and octamethylene diisocyanate; and alicyclic diisocyanates such as xylene diisocyanate. Further examples of isocyanate compounds that may be used include blocked isocyanate compounds obtained by reacting the isocyanate groups on a compound having two or more isocyanate groups on the ends with a compound having active hydrogens, and uretdiones obtained by the dimerization of isocyanate.

The amount of the above isocyanate compounds included per 100 parts by weight of the polyurethane or polyurea resin serving as the base resin is preferably at least 0.1 part by weight, and more preferably at least 0.5 part by weight. The upper limit is preferably not more than 30 parts by weight, and more preferably not more than 20 parts by weight. When too little is included, a sufficient crosslinking reaction may not be obtained and an increase in the properties may not be observable. On the other hand, when too much is included, discoloration over time due to heat and ultraviolet light may increase, or to problems may arise such as a loss of thermoplasticity or a decline in resilience.

In addition, depending on the intended use of the golf ball resin composition of the invention, optional additives may be suitably included in the composition. For example, when the resin composition for golf balls of the invention is to be used as a cover material, various types of additives, such as inorganic fillers, organic staple fibers, reinforcing agents, crosslinking agents, pigments, dispersants, antioxidants, ultraviolet absorbers and light stabilizers, may be added to the foregoing ingredients. When such additives are included, the amount thereof, per 100 parts by weight of the base resin, is preferably at least 0.1 part by weight, and more preferably at least 0.5 part by weight, but preferably not more than 10 parts by weight, and more preferably not more than 4 parts by weight.

The ingredients of the golf ball resin composition of the invention may be prepared by, for example, mixture using any of various types of mixers, such as a kneading-type single-screw or twin-screw extruder, a Banbury mixer, a kneader or a Labo Plastomill. Alternatively, the ingredients may be mixed by dry blending at the time that the resin composition is to be injection molded. In addition, when the above active isocyanate compound is used, it may be incorporated at the time of resin mixture using various types of mixers, or a masterbatch already containing the active isocyanate compound and other ingredients may be separately prepared and the various components mixed together by dry blending at the time that the resin composition is to be injection molded.

The golf ball resin composition of the invention may be used as the resin material for various members of the golf ball. For example, aside from using it as the material for a one-piece golf ball itself, the inventive composition can be suitably used as the cover stock for a two-piece solid golf ball consisting of a core and a cover encasing the core, or as the cover stock in a multi-piece solid golf ball consisting of a core of one or more layer and a multilayer cover encasing the core.

The method of molding such a cover may entail, for example, feeding the above-described resin composition to an injection molding machine and injecting the molten resin composition over the core. In this case, the molding temperature varies depending on the type of polyurethane, polyurea or the like, but is generally in the range of 150° C. to 270° C.

### EXAMPLES

The following Working Examples and Comparative Examples are provided to illustrate the invention, and are not intended to limit the scope thereof.

### Working Examples 1 to 25, Comparative Examples 1 to 11

Cores having a diameter of 38.6 mm were produced by preparing and molding/vulcanizing a core rubber composition formulated as shown in Table 1 which was common to all of the Examples.

TABLE 1

| Rubber composition | Parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic Peroxide (1) | 0.6 |
| Organic Peroxide (2) | 1.2 |
| Zinc salt of | 0.3 |
| pentachlorothiophenol | |
| Zinc stearate | 1.0 |

Details on the above core materials are given below.
cis-1,4-Polybutadiene: Available under the trade name “BR01” from JSR Corporation
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Nocrac NS-6” from Ouchi Shinko Chemical Industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

Next, an intermediate layer-forming resin material common to all of the Examples was prepared. This intermediate layer-forming resin material was a blend of 50 parts by weight of a sodium-neutralized product of an ethylene-unsaturated carboxylic acid copolymer having an acid content of 18 wt % and 50 parts by weight of a zinc-neutralized product of an ethylene-unsaturated carboxylic acid copolymer having an acid content of 15 wt %, the combined amount of both resins being 100 parts by weight. This resin material was injection-molded over the 38.6 mm diameter core obtained as described above, thereby producing an intermediate layer-encased sphere having a 1.25 mm thick intermediate layer.

Next, the cover materials formulated as shown in Table 2 below were injection-molded over the intermediate layer-encased spheres, thereby producing 42.7 mm diameter three-piece golf balls having a 0.8 mm thick cover layer (outermost layer). Dimples common to all the Examples were formed at this time on the surface of the cover in each of the Working Examples and Comparative Examples.

### Preparation of Cover Resin Compositions

The resin compositions were prepared by using the seven types of polyurethane resin (TPU1 to TPU7) shown in Table 2 below as the primary ingredient and blending into this, as an included ingredient, the styrenic resin material shown in Tables 4 to 7 below. In Comparative Example 3, a polyester elastomer (PEs) was used. The numbers shown in Tables 4 to 7 below for “included ingredient content” represent the number of parts by weight per 100 parts by weight of the respective polyurethane resin ingredients (TPU1 to TPU7).

TABLE 2

| | Cover resin (pbw) | | | | | | |
|---|---|---|---|---|---|---|---|
| | TPU1 | TPU2 | TPU3 | TPU4 | TPU5 | TPU6 | TPU7 |
| Urethane | ether-based | ether-based | ether-based | ether-based | ether-based | ether-based | ether-based |
| resin type | | | | | | | |
| Isocyanate | MDI | MDI | MDI | MDI | MDI | MDI | MDI |
| component | | | | | | | |
| Polyol | PTMG | PTMG | PTMG | PTMG | PTMG | PTMG | polybutylene |
| component | 2000 | 2000 | 2000 | 2000 | 2000 | 1000 | adipate |
| Resin hardness | 40 | 44 | 47 | 50 | 57 | 50 | 35 |
| (Shore D) | | | | | | | |

The urethane resins TPU1 to TPU7 mentioned in Table 2 were as follows.
TPU1 to TPU6: Ether-type thermoplastic polyurethanes available under the trade name Pandex from DIC Covestro Polymer, Ltd.
   Also, TPU1 to TPU5 are each composed of polyol (PTMG 2000)/isocyanate (MDI)/chain extender/various additives, the hardnesses of which are adjusted by the polyol (PTMG 2000)/isocyanate (MDI)/chain extender ratio.
TPU7: An ester-type thermoplastic polyurethane available from DIC Covestro Polymer, Ltd.
MDI: 4,4′-Diphenylmethane diisocyanate (an isocyanate compound)

Details on the “included ingredient” in Tables 4 to 7 below are as follows.
HIPS: A high-impact polystyrene resin available from DIC Corporation under the trade name DIC Styrene MH-6800-1
GPPS: A general-purpose polystyrene resin available from DIC Corporation under the trade name DIC Styrene CR-2500
SEBS: A styrenic block copolymer available from Kuraray Co., Ltd.
PEs: A polyester elastomer available from DuPont-Toray Co., Ltd. under the trade name Hytrel 4001

### FT-IR Absorbance

For each golf ball obtained in the Working Examples and Comparative Examples, a section of the cover was cut from the golf ball when at least one week had elapsed after molding, and the infrared absorption spectrum (as a plot of absorbance versus wave number) at the cover interior was measured by ATR/FT-IR spectroscopy. To increase the accuracy of the measured data, each absorbance peak height was determined by carrying out measurement N times so that the percent relative standard deviation (referred to below as “RSD %”) becomes 3.0% or less.

The instrument used for FT-IR measurement was the Spectrum 100, System B Fourier-transform infrared spectrophotometer from Perkin Elmer. Samples were measured under the following conditions.
Measurement method: Attenuated total reflection (ATR)
Detector: FR-DTGS
Resolution: 4 cm⁻¹
Number of runs: 16
Measurement wave number range: 4000 cm⁻¹ to 650 cm⁻¹
Place of measurement: Measured at random places of cover interior in cut section of cover

As shown in Table 3 below, when correcting and determining the P1 to P4 absorbances, the surface/height for each peak was enlarged as shown in FIGS. 2 to 5, a baseline was assigned to each, and the peak heights P1 to P4 following correction were read off.

TABLE 3

| Peak height | Wave number | Baseline |
|---|---|---|
| P1 | near 697 cm⁻¹ | 714 to 688 cm⁻¹ |
| P2 | near 1512 cm⁻¹ | 1572 to 1494 cm⁻¹ |
| P3 | near 2853 cm⁻¹ | 2893 to 2816 cm⁻¹ |
| P4 | near 1180 cm⁻¹ | 1290 to 1153 cm⁻¹ |

For each golf ball obtained in the Working Examples and Comparative Examples, the initial velocity on shots with a driver and the initial velocity on approach shots were measured, in addition to which the moldability, scuff resistance, durability, distance performance and sensory qualities on approach shots were evaluated as described below. These results are presented in Tables 4 to 7.

With regard to the initial velocity difference and distance performance on shots with a driver and to the initial velocity difference on approach shots, Table 4 shows the amount of change in Working Examples 1 to 10 and Comparative Examples 2 and 3 relative to Comparative Example 1 as the reference; Table 5 shows the amount of change in Working Examples 11 to 16 and Comparative Examples 5 relative to Comparative Example 4 as the reference; Table 6 shows the amount of change in Working Examples 17 to 22 and Comparative Example 7 relative to Comparative Example 6 as the reference: and Table 7 shows the amount of change in Working Example 23 relative to Comparative Example 8, the amount of change in Working Example 24 relative to Comparative Example 9, the amount of change in Working Example 25 relative to Comparative Example 10, and the amount of change in Comparative Example 11 relative to Comparative Example 1. With regard to the molding temperature when injection-molding the cover material, Table 4 shows the molding temperature difference in Working Examples 1 to 10 and Comparative Examples 2 and 3 relative to Comparative Example 1 as the reference. Table 5 shows the molding temperature difference in Working Examples 11 to 16 and Comparative Example 5 relative to Comparative Example 4 as the reference, and Table 6 shows the molding temperature difference in Working Examples 17 to 22 and Comparative Example 7 relative to Comparative Example 6 as the reference. Also, Table 7 shows the molding temperature difference in Working Example 23 relative to Comparative Example 8, the molding temperature difference in Working Example 24 relative to Comparative Example 9, the molding temperature difference in Working Example 25 relative to Comparative Example 10, and the molding temperature difference in Comparative Example 11 relative to Comparative Example 1.

Evaluation of Ball on Shots with a Driver

The initial velocity of the ball immediately after being struck at a head speed (HS) of 45 m's with a driver mounted on a swing robot was measured using an apparatus for measuring the initial conditions. The distance traveled by the ball was measured as well. The flight performance (distance) was rated according to the following criteria.

Good: No decrease in distance

Fair: Distance decreased by less than 5 m

NG: Distance decreased by 5 m or more

### Evaluation of Ball on Approach Shots

A sand wedge (SW) was mounted on a golf swing robot and the initial velocity of the ball immediately after being struck at a head speed (HS) of 20 m/s was measured with an apparatus for measuring the initial conditions. In addition, sensory evaluation of the ball on approach shots was carried out according to the following criteria.

Good: Excellent controllability

Fair: Good controllability

NG: Somewhat poor controllability

### Evaluation of Moldability (Mold Releasability)

Releasability from the mold following injection molding of the cover was rated according to the following criteria.
Good: External defects such as runner stubs and ejector pin marks do not arise during demolding.
Fair: External defects such as runner stubs and ejector pin marks arise during demolding, but molding proceeds without difficulty.
NG: External defects such as runner stubs and ejector pin marks arise during demolding, and molding is impossible.

### Evaluation of Scuff Resistance

The golf balls were held isothermally at 23° C. and five balls of each type were hit at a head speed of 33 m/s using a pitching wedge mounted on a swing robot machine. The damage to the ball from the impact was visually rated according to the following criteria.
Good: Damage is very slight or substantially not apparent.
Fair: Some fraying of surface or loss of dimples.
NG: Dimples are completely obliterated in places.

### Evaluation of Durability

The durability of the golf ball was evaluated by firing the ball pneumatically and causing it to repeatedly strike two metal plates arranged in parallel at an incident velocity of 43 m/s, and then measuring the number of shots required for the golf ball to crack. The average of the measurements for ten golf balls was determined, and the durability was rated according to the following criteria.
Good 100 or more shots
NG: Less than 100 shots

TABLE 4

| | | Comp. | | | | | | | | | Comparative | | Working | |
|---|---|---|---|---|---|---|---|---|---|---|---|---|---|---|
| | | Ex. | Working Example | | | | | | | | Example | | Example | |
| | | 1 | 1 | 2 | 3 | 4 | 5 | 6 | 7 | 8 | 2 | 3 | 9 | 10 |
| Peak | P1 | 0.00 | 0.01 | 0.02 | 0.03 | 0.05 | 0.07 | 0.09 | 0.11 | 0.13 | 0.17 | 0.00 | 0.03 | 0.11 |
| intensity | P2 | 0.14 | 0.15 | 0.15 | 0.15 | 0.13 | 0.12 | 0.11 | 0.11 | 0.10 | 0.08 | 0.13 | 0.15 | 0.11 |
| | P3 | 0.13 | 0.13 | 0.13 | 0.13 | 0.13 | 0.12 | 0.12 | 0.12 | 0.11 | 0.11 | 0.13 | 0.13 | 0.13 |
| | P4 | 0.04 | 0.04 | 0.05 | 0.05 | 0.04 | 0.04 | 0.04 | 0.04 | 0.03 | 0.03 | 0.04 | 0.04 | 0.04 |
| Peak | P1/P2 | 0.00 | 0.08 | 0.11 | 0.24 | 0.43 | 0.58 | 0.78 | 1.06 | 1.34 | 2.18 | 0.00 | 0.21 | 0.93 |
| intensity | P2/P3 | 1.06 | 1.12 | 1.14 | 1.13 | 0.97 | 0.98 | 0.93 | 0.89 | 0.86 | 0.71 | 1.00 | 1.13 | 0.90 |
| ratio | P4/P2 | 0.30 | 0.30 | 0.34 | 0.32 | 0.35 | 0.34 | 0.35 | 0.34 | 0.34 | 0.37 | 0.28 | 0.30 | 0.32 |
| Cover | TPU | TPU1 | TPU1 | TPU1 | TPU1 | TPU1 | TPU1 | TPU1 | TPU1 | TPU1 | TPU1 | TPU1 | TPU1 | TPU1 |
| resin | Type | ether- | ether- | ether- | ether- | ether- | ether- | ether- | ether- | ether- | ether- | ether- | ether- | ether- |
| composition | | based | based | based | based | based | based | based | based | based | based | based | based | based |
| | Included | — | HIPS | HIPS | HIPS | HIPS | HIPS | HIPS | HIPS | HIPS | HIPS | PEs | GPPS | SEBS |
| | ingredient | | | | | | | | | | | | | |
| | Content of | 0 | 1 | 2 | 3 | 10 | 25 | 35 | 50 | 60 | 80 | 3 | 3 | 15 |
| | included | | | | | | | | | | | | | |
| | ingredient | | | | | | | | | | | | | |
| Ball | DR initial | 66.82 | 66.83 | 66.83 | 66.82 | 66.83 | 66.83 | 66.83 | 66.84 | 66.8 | 66.79 | 66.84 | 66.84 | 66.82 |
| evaluation | velocity (m/sec) | | | | | | | | | | | | | |
| | AP initial | 19.18 | 19.16 | 19.1 | 19.09 | 19.09 | 19 | 18.95 | 18.85 | 18.82 | 18.72 | 19.18 | 19.16 | 19.09 |
| | velocity (m/sec) | | | | | | | | | | | | | |
| | DR initial velocity | — | 0.01 | 0.01 | 0.00 | 0.01 | 0.01 | 0.01 | 0.00 | −0.02 | −0.04 | 0.02 | 0.02 | 0.00 |
| | difference (m/sec) | | | | | | | | | | | | | |
| | AP initial velocity | — | −0.02 | −0.08 | −0.09 | −0.11 | −0.18 | −0.20 | −0.23 | −0.28 | −0.33 | 0.00 | −0.02 | −0.09 |
| | difference (m/sec) | | | | | | | | | | | | | |
| | Molding | — | 0 | −6 | −9 | −16 | −20 | −23 | −27 | −29 | −32 | 0 | 0 | 0 |
| | temperature | | | | | | | | | | | | | |
| | difference (° C.) | | | | | | | | | | | | | |
| | Moldability | Good | Good | Good | Good | Good | Good | Good | Good | Fair | NG | Good | Good | Good |
| | (mold releasability) | | | | | | | | | | | | | |
| | Distance | Good | Good | Good | Good | Good | Good | Good | Good | Good | Fair | Good | Good | Good |
| | performance | | | | | | | | | | | | | |
| | Controllability | NG | Fair | Good | Good | Good | Good | Good | Good | Good | Good | NG | Fair | Good |
| | on approach shots | | | | | | | | | | | | | |
| | Scuff resistance | Good | Good | Good | Good | Good | Good | Good | Good | Fair | NG | Good | Good | Good |
| | Durability | Good | Good | Good | Good | Good | Good | Good | Good | Good | Good | Good | Good | Good |

DR initial velocity: initial velocity on shots with a driver
AP initial velocity: Initial velocity on approach shots with an iron

TABLE 5

| | | Comp. | | | | | | | Comp. |
|---|---|---|---|---|---|---|---|---|---|
| | | Example | Working Example | | | | | | Example |
| | | 4 | 11 | 12 | 13 | 14 | 15 | 16 | 5 |
| Peak | P1 | 0.00 | 0.01 | 0.02 | 0.04 | 0.10 | 0.15 | 0.20 | 0.23 |
| intensity | P2 | 0.16 | 0.14 | 0.14 | 0.13 | 0.12 | 0.11 | 0.10 | 0.08 |
| | P3 | 0.13 | 0.13 | 0.13 | 0.13 | 0.12 | 0.10 | 0.08 | 0.07 |
| | P4 | 0.05 | 0.04 | 0.04 | 0.04 | 0.04 | 0.03 | 0.02 | 0.01 |
| Peak | P1/P2 | 0.00 | 0.10 | 0.16 | 0.30 | 0.89 | 1.43 | 1.96 | 2.77 |
| intensity | P2/P3 | 1.24 | 1.12 | 1.14 | 1.07 | 0.99 | 1.06 | 1.21 | 1.15 |
| ratio | P4/P2 | 0.30 | 0.30 | 0.30 | 0.32 | 0.35 | 0.30 | 0.18 | 0.16 |
| Cover resin | TPU | TPU2 | TPU2 | TPU2 | TPU2 | TPU2 | TPU2 | TPU2 | TPU2 |
| composition | Type | ether- | ether- | ether- | ether- | ether- | ether- | ether- | ether- |
| | | based | based | based | based | based | based | based | based |
| | Included ingredient | — | HIPS | HIPS | HIPS | HIPS | HIPS | HIPS | HIPS |
| | Content of | 0 | 2 | 3 | 5 | 10 | 25 | 50 | 60 |
| | included ingredient | | | | | | | | |
| Ball | DR initial velocity (m/sec) | 66.82 | 66.82 | 66.83 | 66.83 | 66.82 | 66.81 | 66.81 | 66.77 |
| evaluation | AP initial velocity (m/sec) | 19.12 | 19.04 | 19.02 | 19.02 | 18.99 | 18.94 | 18.88 | 18.85 |
| | DR initial velocity | — | 0.00 | 0.01 | 0.01 | 0.00 | −0.01 | −0.01 | −0.05 |
| | difference (m/sec) | | | | | | | | |
| | AP initial velocity | — | −0.08 | −0.10 | −0.10 | −0.13 | −0.18 | −0.24 | −0.27 |
| | difference (m/sec) | | | | | | | | |
| | Molding temperature | 0 | −3 | −5 | −7 | −12 | −17 | −23 | −26 |
| | difference (° C.) | | | | | | | | |
| | Moldability | Good | Good | Good | Good | Good | Good | Fair | NG |
| | (mold releasability) | | | | | | | | |
| | Distance performance | Good | Good | Good | Good | Good | Good | Good | Fair |
| | Controllability | NG | Good | Good | Good | Good | Good | Good | Good |
| | on approach shots | | | | | | | | |
| | Scuff resistance | Good | Good | Good | Good | Good | Good | Fair | NG |
| | Durability | Good | Good | Good | Good | Good | Good | Good | Good |

TABLE 6

| | | Comp. | | | | | | | Comp. |
|---|---|---|---|---|---|---|---|---|---|
| | | Example | Working Example | | | | | | Example |
| | | 6 | 17 | 18 | 19 | 20 | 21 | 22 | 7 |
| Peak | P1 | 0.00 | 0.02 | 0.03 | 0.04 | 0.09 | 0.17 | 0.20 | 0.25 |
| intensity | P2 | 0.16 | 0.15 | 0.15 | 0.14 | 0.13 | 0.11 | 0.10 | 0.09 |
| | P3 | 0.12 | 0.12 | 0.12 | 0.12 | 0.12 | 0.11 | 0.09 | 0.08 |
| | P4 | 0.05 | 0.05 | 0.05 | 0.05 | 0.04 | 0.04 | 0.03 | 0.02 |
| Peak | P1/P2 | 0.00 | 0.11 | 0.20 | 0.30 | 0.68 | 1.48 | 1.98 | 2.85 |
| intensity | P2/P3 | 1.30 | 1.25 | 1.24 | 1.17 | 1.07 | 1.05 | 1.11 | 1.04 |
| ratio | P4/P2 | 0.28 | 0.31 | 0.32 | 0.34 | 0.34 | 0.33 | 0.26 | 0.25 |
| Cover resin | TPU | TPU3 | TPU3 | TPU3 | TPU3 | TPU3 | TPU3 | TPU3 | TPU3 |
| composition | Type | ether- | ether- | ether- | ether- | ether- | ether- | ether- | ether- |
| | | based | based | based | based | based | based | based | based |
| | Included ingredient | — | HIPS | HIPS | HIPS | HIPS | HIPS | HIPS | HIPS |
| | Content of | 0 | 2 | 3 | 5 | 10 | 25 | 50 | 60 |
| | included ingredient | | | | | | | | |
| Ball | DR initial velocity (m/sec) | 66.82 | 66.83 | 66.81 | 66.81 | 66.83 | 66.83 | 66.81 | 66.78 |
| evaluation | AP initial velocity (m/sec) | 19.08 | 19 | 18.97 | 18.97 | 18.96 | 18.89 | 18.85 | 18.8 |
| | DR initial velocity | — | 0.01 | −0.01 | −0.01 | 0.01 | 0.01 | −0.01 | −0.04 |
| | difference (m/sec) | | | | | | | | |
| | AP initial velocity | — | −0.08 | −0.11 | −0.11 | −0.12 | −0.19 | −0.23 | −0.28 |
| | difference (m/sec) | | | | | | | | |
| | Molding temperature | 0 | −2 | −5 | −6 | −9 | −13 | −18 | −20 |
| | difference (° C.) | | | | | | | | |
| | Moldability | Good | Good | Good | Good | Good | Good | Fair | NG |
| | (mold releasability) | | | | | | | | |
| | Distance performance | Good | Good | Good | Good | Good | Good | Good | Fair |
| | Controllability | NG | Good | Good | Good | Good | Good | Good | Good |
| | on approach shots | | | | | | | | |
| | Scuff resistance | Good | Good | Good | Good | Good | Good | Fair | NG |
| | Durability | Good | Good | Good | Good | Good | Good | Good | Good |

TABLE 7

| | | Comp. | Working | Comp. | Working | Comp. | Working | Comp. |
|---|---|---|---|---|---|---|---|---|
| | | Example | Example | Example | Example | Example | Example | Example |
| | | 8 | 23 | 9 | 24 | 10 | 25 | 11 |
| Peak | P1 | 0.00 | 0.02 | 0.00 | 0.02 | 0.00 | 0.03 | 0.00 |
| intensity | P2 | 0.17 | 0.15 | 0.20 | 0.16 | 0.19 | 0.15 | 0.13 |
| | P3 | 0.12 | 0.12 | 0.11 | 0.11 | 0.10 | 0.10 | 0.08 |
| | P4 | 0.05 | 0.05 | 0.07 | 0.05 | 0.06 | 0.05 | 0.07 |
| Peak | P1/P2 | 0.00 | 0.16 | 0.00 | 0.12 | 0.00 | 0.17 | 0.00 |
| intensity | P2/P3 | 1.41 | 1.27 | 1.88 | 1.39 | 2.00 | 1.45 | 1.66 |
| ratio | P4/P2 | 0.29 | 0.32 | 0.32 | 0.32 | 0.34 | 0.34 | 0.54 |
| Cover resin | TPU | TPU4 | TPU4 | TPU5 | TPU5 | TPU6 | TPU6 | TPU7 |
| composition | Type | ether- | ether- | ether- | ether- | ether- | ether- | ether- |
| | | based | based | based | based | based | based | based |
| | Included ingredient | — | HIPS | — | HIPS | — | HIPS | — |
| | Content of | 0 | 3 | 0 | 3 | 0 | 3 | 0 |
| | included ingredient | | | | | | | |
| Ball | DR initial velocity (m/sec) | 66.84 | 66.84 | 66.84 | 66.85 | 66.67 | 66.67 | 66.65 |
| evaluation | AP initial velocity (m/sec) | 19.03 | 18.92 | 18.97 | 18.84 | 18.83 | 18.76 | 19.08 |
| | DR initial velocity | — | 0.00 | — | 0.01 | — | 0.00 | −0.17 |
| | difference (m/sec) | | | | | | | |
| | AP initial velocity | — | −0.11 | — | −0.13 | — | −0.07 | −0.10 |
| | difference (m/sec) | | | | | | | |
| | Molding temperature | 0 | −5 | 0 | −5 | 0 | −5 | 14 |
| | difference (° C.) | | | | | | | |
| | Moldability | Good | Good | Good | Good | Good | Good | Good |
| | (mold releasability) | | | | | | | |
| | Distance performance | Good | Good | Good | Good | Good | Good | Fair |
| | Controllability | NG | Good | NG | Good | NG | Good | Good |
| | on approach shots | | | | | | | |
| | Scuff resistance | Good | Good | Good | Good | Fair | Fair | Good |
| | Durability | Good | Good | Good | Good | Good | Good | NG |

The results in Tables 4 to 7 demonstrate that the golf balls of Working Examples 1 to 25 are able to hold down the rebound (initial velocity) on approach shots without a loss of rebound (initial velocity) on shots with a driver and thus without a drop in the distance performance, enabling the controllability on approach shots to be improved while maintaining a good distance on shots with a driver. No loss of good scuff resistance or durability was observed in these balls.

Japanese Patent Application No. 2018-117140 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A resin composition for golf balls comprising polyurethane or polyurea as a primary ingredient, wherein, letting P1 be the absorbance peak height near a wave number of 697 cm⁻¹ and P2 be the absorbance peak height near a wave number of 1512 cm⁻¹ when the infrared absorption spectrum of the composition measured by the attenuated total reflectance method in Fourier transform infrared absorption spectroscopy (ATR/FT-IR spectroscopy) is plotted as absorbance versus wave number, the ratio P1/P2 is from 0.03 to 2.10.

2. The resin composition of claim 1, further comprising one or more resin selected from the group consisting of polystyrene (PS), general-purpose polystyrene resins (GPPS), high-impact polystyrene resins (HIPS), styrene-isoprene-styrene block copolymers (SIS), styrene-butadiene-styrene block copolymers (SBS), styrene-ethylene/butadiene-styrene block copolymers (SEBS), styrene-ethylene/isoprene-styrene block copolymers (SEPS), acrylonitrile/styrene copolymers (AS), acrylonitrile/ethylene-propylene-nonconjugated diene rubber/styrene copolymers (AES), acrylonitrile/butadiene/styrene copolymers (ABS), methyl methacrylate/butadiene/styrene copolymers (MBS) and acrylonitrile/styrene/acrylic rubber copolymers (ASA).

3. The resin composition of claim 1 wherein, letting P3 be the absorbance peak height near a wave number of 2853 cm⁻¹ as measured by ATR FT-IR spectroscopy, the value P2/P3 is 2.0 or less.

4. The resin composition of claim 1 wherein, letting P4 be the absorbance peak height near a wave number of 1180 cm⁻¹ as measured by ATR/FT-IR spectroscopy, the value P4/P2 is 0.53 or less.

5. The resin composition of claim 1, wherein the polyurethane serving as the primary ingredient of the resin composition is an ether-based thermoplastic polyurethane.

6. The resin composition of claim 1, wherein the polyurethane serving as the primary ingredient of the resin composition has a polyol component that includes polytetramethylene ether glycol (PTMG).

7. The resin composition of claim 1, wherein the polyurethane or polyurea serving as the primary ingredient of the resin composition has an isocyanate component that is one or more selected from the group consisting of tolylene-2,6-diisocyanate, tolyene-2,4-diisocyanate, 4,4′-diphenylmethanediisocyanate, polymethylene polyphenyl polyisocyanate, 1,5-diisocyanatonaphthalene, isophorone diisocyanate (including isomer mixtures), to dicyclohexylmethane-4,4′-diisocyanate, hexamethylene-1,6-diisocyanate, m-xylylene diisocyanate, hydrogenated xylylene diisocyanate, tolidine diisocyanate and norbornene diisocyanate, derivatives thereof, and prepolymers formed of said isocyanate compounds.

8. A golf ball comprising a core and a cover of one or more layer encasing the core, wherein at least one layer of the cover is formed of the resin composition of claim 1.
